(19) United States
(12) Patent Application Publication
(10) Pub. No.: US 2015/0253200 A1
(43) Pub. Date: Sep. 10, 2015

(54) ELECTRONIC THERMOMETER AND A CONTROL METHOD

(71) Applicant: XIAMEN ANTS-BRO TECHNOLOGY CO., LTD., Xiamen, Fujian (CN)

(72) Inventor: Chaowen Wang, Xiamen (CN)

(73) Assignee: XIAMEN ANTS-BRO TECHNOLOGY CO., LTD., Xiamen, Fujian (CN)

(21) Appl. No.: 14/423,153

(22) PCT Filed: Aug. 8, 2013
(86) PCT No.: PCT/CN2013/081038

§ 371 Date: Feb. 23, 2015

(30) Foreign Application Priority Data
Aug. 23, 2012 (CN) 201210304351.2
Oct. 31, 2012 (CN) 201210432258.X

(51) Int. Cl. G01K 1/02; G01K 7/00

(52) U.S. Cl. CPC G01K 1/02; G01K 7/00

(57) ABSTRACT

An electronic thermometer and a control method thereof. The electronic thermometer comprises a single chip, a thermometric component, a LCD, a circuit board, a housing and a battery; the circuit board is disposed with a switch type vibration transducer to provide shaking signal to the control input port of the single chip, the vibration transducer is disposed with a conductive elastic body and a conductive fixed body, the elastic body is contacted with the fixed body or being away from the fixed body when moving in the housing. The present invention can turn to be in thermometric state from standby state by a user's shaking, or turn to be in standby state from thermometric state.

### FIELD OF THE INVENTION

The present invention relates to a medical measure device and a control method thereof.

### BACKGROUND OF THE INVENTION

Exiting know electronic thermometer comprises a single chip as a control unit, buttons to route commands, a thermometric component to measure the temperature, an LCD to display the temperature, a circuit board, a bar shaped housing and a battery. When in standby state, the LCD does not display any information, the thermometric component does not work, the single chip is in standby and power saving state. When the single chip detects a signal from the button (temperature measuring instruction), the single chip controls the thermometric component and the LCD to work, the electronic thermometer enters to temperature measuring state. The single chip transfers the temperature signal from the thermometric component to digital value to display in the LCD, so that the LCD keeps displaying the temperature data. When the single chip gets a signal from the button again (quit instruction), the single chip controls the thermometric component and the LCD not to work, so that the LCD does not display any information, the electronic thermometer returns to standby state. As the buttons to control the electronic thermometer is mechanical type, the buttons are easily to take water in, and limited by the size of the side wall of the housing, the button size must be made small, that makes a bad operation feel and inconvenient operation.

A touch sense switch electronic thermometer is disclosed in Chinese patent database with patent number ZL201020665726.4, the touch sense switch is touched to react by hand or metal articles, it is easy to operate, but it is easy to misoperate, it costs high and is not easy to assemble.

### SUMMARY OF THE INVENTION

The present invention is provided with an electronic thermometer and a control method thereof with well waterproof and easy operation and against misoperation.

The technical proposal of the present invention is that: An electronic thermometer, comprising a single chip, a thermometric component, an LCD, a circuit board, a housing and a battery;

the circuit board is disposed with a switch type vibration transducer to provide a vibration signal to the control input port of single chip, the vibration transducer comprises a conductive elastic body and a conductive fixed body;

when the housing moves, the elastic body turns into being separated from the fixed body from being contacted with the fixed body; or the elastic body turns into being contacted with the fixed body from being separated from the fixed body.

A control method of above electronic thermometer, the electronic thermometer has two working state, a standby condition and thermometric state;

in standby state, the single chip controls the LCD and the thermometric component to be in inoperation state; the single chip simultaneously performs shaking identification, when the single chip detects that the duration of a motion signal of the vibration transducer is equal to the rated value, a vibration signal is determined, the electronic thermometer turns to thermometric state;

in thermometric state, the single chip controls the LCD and the thermometric component to be in operation state; the single chip converts the temperature signal provided by the thermometric component to digital value at regular intervals, every new digital value comes in, the single chip checks whether the new digital value is larger than the digital value of the LCD, if so, the new digital value is displayed in the LCD; the single chip simultaneously performs shaking identification, when the single chip detects that the duration of a motion signal of the vibration transducer is equal to the rated value, a vibration signal is determined, the electronic thermometer returns to the standby state.

A first shaking identification of the standby state and the thermometric state comprises following substeps:

substep 1, waiting for a motion signal to trigger, once the single chip detects a motion signal of the vibration transducer from a static state to a motion state, performing the substep 2;

substep 2, starting the timer, the single chip starts the timer with loop count, then performing substep 3;

substep 3, determining a static signal to trigger, the single chip detects whether there is a signal of the vibration transducer from the motion state to the static state, if so, performing substep 1, if not, performing substep 4;

substep 4, determining whether it reaches to motion time threshold value, the single chip detects whether the value of the timer reaches to the preset threshold value of motion duration, if so, performing substep 5, if not, performing substep 3;

substep 5, the end, the single chip turns off the timer.

In this embodiment, from the moment that the single chip detects that the vibration transducer is triggered by a motion signal from a static position to a dynamic position, to the moment that the duration of the motion signal is equal to the rated value, the motion time threshold, if the single chip detects that the vibration transducer is triggered by a static signal from a dynamic position to a static position, it judges that the motion signal is produced by electronic thermometer free falling, falling, collision or bumps of transportation, ignoring it and restart to waiting for shaking signal; otherwise, it judges that a user squeezes the electronic thermometer and shakes it, the single chip issues a commend to enter to the thermometric operation or quit. This embodiment is simple and easy, it is applicable for vibration transducers with high sensitivity.

A second shaking identification of the standby state and the thermometric state comprises following substeps:

substep 1′, waiting for a motion signal to trigger, once the single chip detects a motion signal of the vibration transducer from a static state to a motion state, performing the substep 2′;

substep 2′, starting the timer, the single chip starts the timer with loop count, then performing substep 3′;

substep 3′, determining whether it reaches to the duration threshold value, the single chip detects whether the value of the timer reaches to the preset threshold value, if so, performing substep 4′, if not, performing this substep again;

substep 4′, determining a motion signal, the single chip detects whether the vibration transducer outputs a motion signal, if so, performing substep 5′, if not, performing substep 1′;

substep 5, the end, the single chip turns off the timer.

In this embodiment, from the moment that the single chip detects that the vibration transducer is triggered by a motion signal from a static position to a dynamic position, to the moment that the duration of the motion signal is equal to the rated value (the motion time threshold), if the single chip detects that the output of the vibration transducer is a static signal, it judges that the motion signal is produced by electronic thermometer free falling, falling, collision or bumps of transportation, ignoring it and restart to waiting for shaking signal; otherwise, it judges that a user squeezes the electronic thermometer and shakes it, the single chip issues a commend to enter to the thermometric operation or quit. This embodiment is simple and easy, it is applicable for vibration transducers with low sensitivity.

A third shaking identification of the standby state and the thermometric state comprises following substeps:

substep 1″, clearing the static and motion counters, the single chip clears the values of the static counter and motion counter, performing the substep 2″;

substep 2″, waiting for a motion signal to trigger, once the single chip detects a motion signal of the vibration transducer from a static state to a motion state, performing the substep 3″;

substep 3″, starting the timer, the single chip starts the timer with loop count, then performing substep 4″;

substep 4″, detecting the state of the vibration transducer, the single chip detects the output signal of the vibration transducer, performing substep 5″;

substep 5″, determining whether there is a motion signal, the single chip detects whether the vibration transducer outputs a motion signal, if so, performing substep 6″, if not, performing substep 7″;

substep 6″, the motion counters pluses 1, the single chip pluses 1 to the motion counter, performing substep 61″;

substep 61″, determining whether the motion counter reaches to threshold value, the single chip detects whether the value of the motion counter reaches to the preset threshold value, if so, performing substep 9″, if not, performing substep 8″

substep 7′, the static counter pluses 1, the single chip pluses 1 to the static counter, performing substep 71″;

substep 71″, determining whether the static counter reaches to threshold value, the single chip detects whether the value of the static counter reaches to the preset threshold value, if so, performing substep 1″, if not, performing substep 8″;

substep 8″, waiting for the time alarm, the single chip 1 waits for the time alarm signal, then performing substep 4″,

substep 9″, the end, the single chip turns off the timer.

In this embodiment, from the moment that that the vibration transducer is triggered by a motion signal from a static position to a dynamic position, the single chip collects the output signals of the vibration transducer at timing intervals of the timer, then pluses the times of the output signals of motion status to the motion counter, and pluses the times of the output signals of quiescence status to the quiescence counter, if the value of the quiescence counter reaches to the preset threshold value, it determines that it is a motion signal caused by like free falling, falling, collision or pumps of transportation, and ignores it, then it clears the counts of the motion counter and the quiescence counter and restart to wait a vibration signal; if the value of the motion counter reaches to the preset threshold valve, it determines that the duration of the motion signal of the vibration transducer is equal to the rated value, it judges that a user squeezes the electronic thermometer and shakes it, the single chip issues a commend to enter to thermometric operation or quit. The present invention has well anti-interference performance and good reliability. The electronic thermometer is applied with switch type vibration with instable output signal to replace existing switch, which is bold, it applies with software technology to identify the motion of a user to shake the electronic thermometer thus to control the electronic thermometer to change between the standby state and the thermometric state. The electronic thermometer of the present invention doesn't need any switch of active buttons, thus improving the waterproof performance of the electronic thermometer, and it has simple structure and it is easy to assemble. The control method of the electronic thermometer is applied with software technology to identify the motion signal of the vibration transducer that is caused by other motions of free falling, falling, collision or transportation, and vibration signal caused by a user squeezing the electronic thermometer and shaking it, the vibration signal is served as a commend to make the electronic thermometer to enter into thermometric state or exit, the operation method of the user squeezing the electronic thermometer and shaking it is similar to the usual method of using the traditional thermometer, so that it is simple, useful, convenient and quick, the method fundamentally avoids the bad hand feeling of mechanical button switch type thermometer and avoids misoperation of touch switch type thermometer.

### BRIEF DESCRIPTION OF THE DRAWINGS

FIG. 1 illustrates a circuit diagram of an electronic thermometer of an embodiment of the present invention.

FIG. 2 illustrates a partial sectional diagram of the embodiment of FIG. 1.

FIG. 3 illustrates a schematic diagram of a first kind of vibration transducer of the embodiment of FIG. 1.

FIG. 4 illustrates a schematic diagram of a second kind of vibration transducer of the embodiment of FIG. 1.

FIG. 5 illustrates a schematic diagram of a third kind of vibration transducer of the embodiment of FIG. 1.

FIG. 6 illustrates a schematic diagram of a fourth kind of vibration transducer of the embodiment of FIG. 1.

FIG. 7 illustrates a schematic diagram of a fifth kind of vibration transducer of the embodiment of FIG. 1.

FIG. 8 illustrates a schematic diagram of a sixth kind of vibration transducer of the embodiment of FIG. 1.

FIG. 9 illustrates a circuit diagram of a first kind of thermometric component of the embodiment of FIG. 1.

FIG. 10 illustrates a circuit diagram of a second kind of thermometric component of the embodiment of FIG. 1.

FIG. 11 illustrates a control flow diagram of the control method of the embodiment of FIG. 1.

FIG. 12 illustrates a control flow diagram of a first kind of shaking identification of FIG. 11.

FIG. 13 illustrates a signal diagram of the vibration transducer of the first kind of shaking identification of FIG. 1.

FIG. 14 illustrates a control flow diagram of a second kind of shaking identification of FIG. 11.

FIG. 15 illustrates a signal diagram of the vibration transducer of the second kind of shaking identification of FIG. 1.

FIG. 16 illustrates a signal diagram of the vibration transducer of the second kind of shaking identification of FIG. 11.

FIG. 17 illustrates a first signal diagram of the vibration transducer of the third kind of shaking identification of the embodiment of FIG. 1.

FIG. 18 illustrates a second signal diagram of the vibration transducer of the third kind of shaking identification of the embodiment of FIG. 1.

FIG. 19 illustrates a third signal diagram of the vibration transducer of the third kind of shaking identification of the embodiment of FIG. 1.

### DETAILED DESCRIPTION OF THE EMBODIMENTS

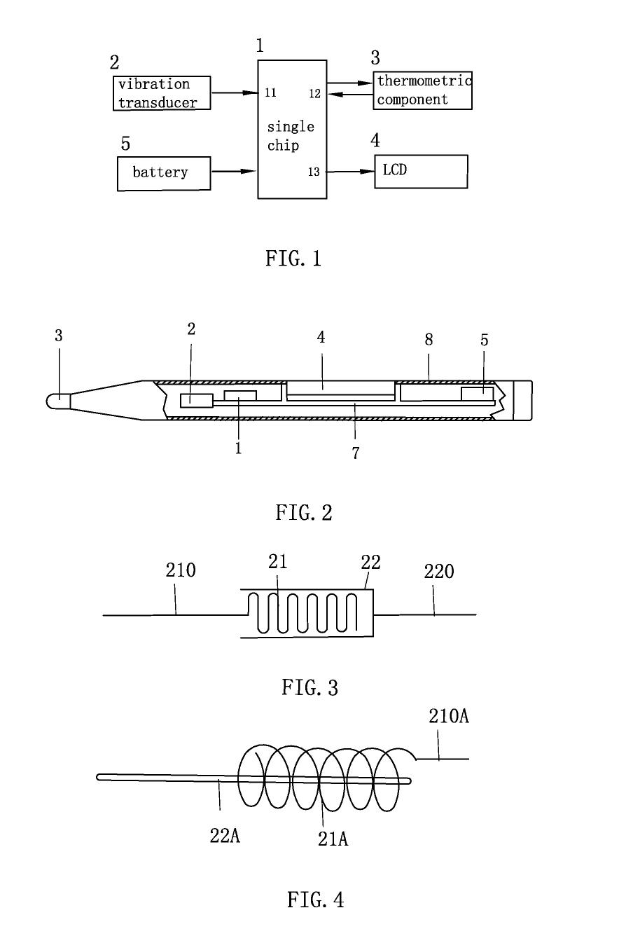

A circuit structure of an embodiment of an electronic thermometer is figured in FIG. 1. The electronic thermometer is disposed with a single chip 1, a vibration transducer 2, a thermometric component 4, an LCD 4 and a battery 5. The battery 5 supplies power to the single chip 1, the single chip 1 controls the LCD 4 and the thermometric component 3 to work. The switch type vibration transducer 2 is connected to the control input port 11 of the single chip 1 to provide vibration signal to the control input port 11 of the single chip 1. The thermometric component 3 is connected to the temperature signal input port 12 of the single chip 1, the LCD 4 is connected to the display output port 13 of the single chip 1.

Referring to FIG. 2, the thermometric component 3 is attached to the front end of a rod shaped housing 8; the single chip 1, the vibration transducer 2, the LCD 4 and the battery 5 are attached to the circuit board 7 of the housing 8, the display surface of the LCD 4 is exploded out of the window of the side wall of the housing 8.

The vibration transducer 2 has various types; every kind of vibration transducer 2 has a conductive elastic body and a conductive fixed body. For example:

FIG. 3 illustrates a normal open switch type vibration transducer, the elastic body 21 is a circular tube, the fixed body 22 is a cylinder. The elastic body 21 is suspended in the inner hole of the fixed body 22; the external edge of the elastic body 21 is disposed with a outgoing line 210 along the longitudinal axis, the external edge of the fixed body 22 is disposed with a outgoing line 220 along the longitudinal axis. The longitudinal axis of the elastic body 21 and the fixed body 22 assembling in the housing 8 coincides with the longitudinal axis of the housing 8, the elastic body 21, moving in the housing 8 back and forth in the radial direction, changes to contact with the fixed body 22 from being away from the fixed body 22.

FIG. 4 illustrates a normal open switch vibration transducer, the elastic body 21A is a coil spring, the fixed body 22A is a rod. The fixed body 22A is suspended in the inner hole of the elastic body 21A; the external edge of the elastic body 21A is disposed with a outgoing line 210A along the longitudinal axis, the longitudinal axis of the elastic body 21A and the fixed body 22A assembling in the housing 8 coincides with the longitudinal axis of the housing 8, the elastic body 21A, moving in the housing 8 back and forth in the radial direction, changes to contact with the fixed body 22A from being away from the fixed body 22A.

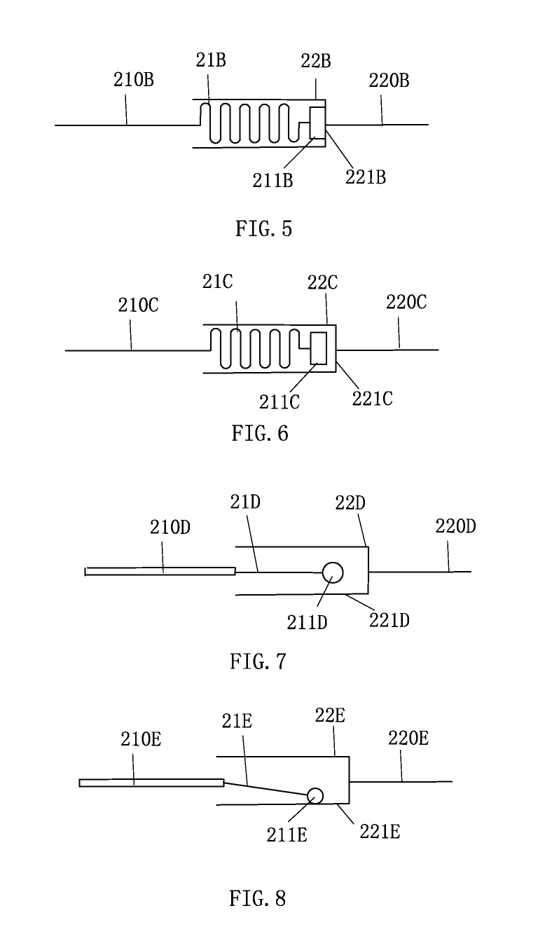

FIG. 5 illustrates a normal closed switch vibration transducer, the elastic body 21B is a coil spring with the free end disposed with a metal block 211B, the fixed body 22B is a cylinder. The elastic body 21B is suspended in the inner hole of the fixed body 22B and the metal block 211B of the free end of the elastic body 21B is contacted with the bottom of the inner hole of the fixed body 22B, the external edge of the elastic body 21B is disposed with a outgoing line 210B along the longitudinal axis, the external edge of the fixed body 22B is disposed with a outgoing line 220B along the longitudinal axis. The longitudinal axis of the elastic body 21B and the fixed body 22B assembling in the housing 8 is vertical to the longitudinal axis of the housing 8, the elastic body 21B, moving in the housing 8 back and forth in the radial direction, changes to be away from the fixed body 22B from being contacted with the fixed body 22B.

FIG. 6 illustrates a normal open switch vibration transducer, the elastic body 21C is a coil spring with the free end disposed with a metal block 211C, the fixed body 22C is a cylinder. The external edge of the elastic body 21C is disposed with a outgoing line 210C along the longitudinal axis, the external edge of the fixed body 22C is disposed with a outgoing line 220C along the longitudinal axis. The elastic body 21C is suspended longitudinally in the inner hole of the fixed body 22C and a clearance is disposed between the metal block 211C of the free end of the elastic body 21C and the bottom 221C of the inner hole of the fixed body 22C. The longitudinal axis of the elastic body 21C and the fixed body 22C assembling in the housing 8 is vertical to the longitudinal axis of the housing 8, the metal block 211C of the free end of the elastic body 21C, moving in the housing 8 back and forth in the radial direction, changes to be away from the bottom 221C of the inner hole of the fixed body from being contacted with the bottom 221C of the inner hole of the fixed body 22C.

FIG. 7 illustrates a normal open switch vibration transducer, the elastic body 21D is a shrapnel with the free end disposed with a metal block 211D, the fixed body 22D is a cylinder. The elastic body 21D is suspended in the inner hole of the fixed body 22D and a clearance is disposed between the metal block 211D of the free end of the elastic body 21D and the side wall 221D of the inner hole of the fixed body 22D. the external edge of the elastic body 21D is disposed with an outgoing line 210D along the longitudinal axis, the external edge of the fixed body 22D is disposed with an outgoing line 220D along the longitudinal axis. The longitudinal axis of the elastic body 21D and the fixed body 22D assembling in the housing 8 coincides with the longitudinal axis of the housing 8, the metal block 211D of the free end of the elastic body 21D, moving in the housing 8 back and forth in the radial direction, changes to be contacted with the side wall 221D of the inner hole of the fixed body 22D from being away from the side wall 221D of the inner hole of the fixed body 22D.

FIG. 8 illustrates a normal closed switch vibration transducer, the elastic body 21E is a shrapnel with the free end disposed with a metal block 211E, the fixed body 22E is a cylinder. The elastic body 21E is suspended in the inner hole of the fixed body 22E and the metal block 211E of the free end of the elastic body 21E is contacted with the side wall 221E of the inner hole of the fixed body 22E. the external edge of the elastic body 21E is disposed with an outgoing line 210E along the longitudinal axis, the external edge of the fixed body 22E is disposed with an outgoing line 220E along the longitudinal axis. The longitudinal axis of the elastic body 21E and the fixed body 22E assembling in the housing 8 coincides with the longitudinal axis of the housing 8, the metal block 211E of the free end of the elastic body 21E, moving in the housing 8 back and forth in the radial direction, changes to be away from the side wall 221E of the inner hole of the fixed body 22D from being contacted with the side wall 221E of the inner hole of the fixed body 22E.

According to the property of the temperature signal input port 12 of the single chip 1, the thermometric component 3 can be applied with different circuit configurations.

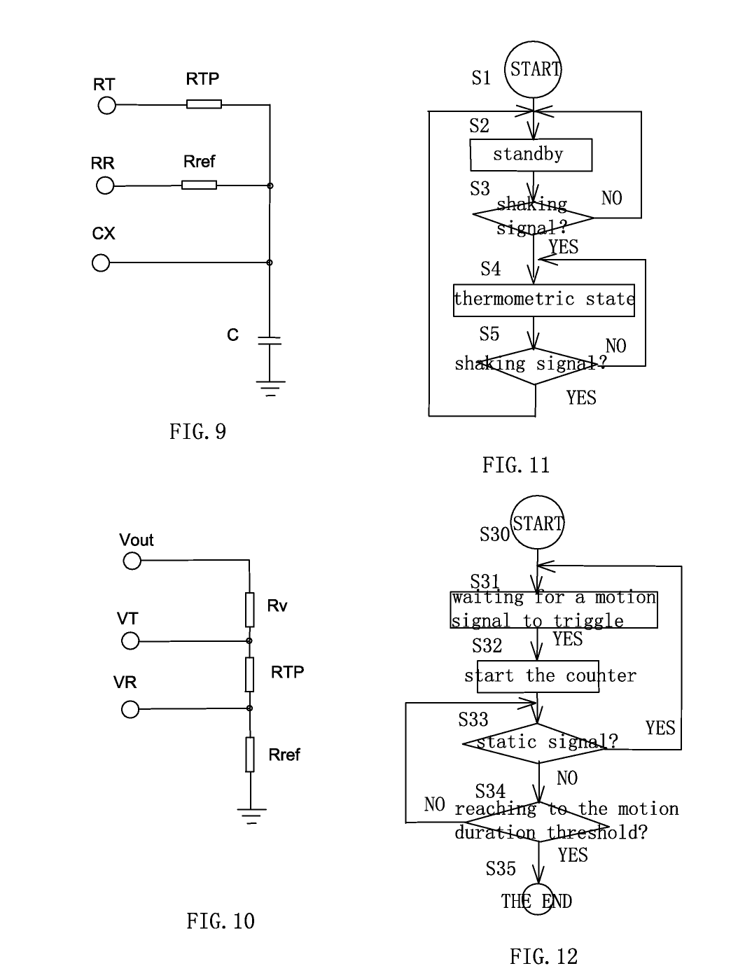

If the temperature signal input port 12 of the single chip 1 is a resistance frequency conversion port, the thermometric component 3 can be applied with the circuit configuration of FIG. 9: the thermistor RTP and the integrating capacitor C are series connected between the thermometric control terminal RT of the single chip 1 and the ground wire. The connector of the thermistor RTP and the integrating capacitor C is disposed with an additional reference resistance Rref and a leading wire, the reference resistance Rref is connected to the reference control terminal RR of the temperature signal input port 12 of the single chip 1, the leasing wire is connected to the test terminal CX of the temperature signal input port 12.

In standby state, the thermometric control terminal RT of the single chip 1 and the reference control terminal RR outputs low level, the thermometric component 3 doesn't generate oscillation.

In thermometric state, in the first step, the reference control terminal of the single chip 1 is suspended, the thermometric control terminal RT of the single chip 1, the test terminal CX, the thermistor RTP and the integrating capacitor C form the oscillating circuit. The thermometric control terminal RT of the single chip 1 outputs high level, and charging the integrating capacitor C by the thermistor RTP, when the test terminal CX detects that the voltage of the integrating capacitor C reaches to high level, the thermometric control terminal RT of the single chip 1 turns to low level, the integrating capacitor C discharges by the thermistor RTP, when the test terminal CX detects that the voltage of the integrating capacitor C reduces to low level, the thermometric control terminal RT outputs high level again. And so forth, the single chip 1 counts the oscillating times CT of the test terminal CX in the stipulated time (for example 0.25 s).

In the second step, the thermometric control terminal RT of the single chip 1 is suspended, the reference control terminal RR of the single chip 1, the test terminal CX, the reference resistance Rref and the integrating capacitor C form the oscillating circuit. The reference control terminal RR of the single chip 1 outputs high level, and charging the integrating capacitor C by the reference resistance Rref, when the test terminal CX detects that the voltage of the integrating capacitor C reaches to high level, the reference control terminal RR of the single chip 1 turns to low level, the integrating capacitor C discharges by the thermistor RTP, when the test terminal CX detects that the voltage of the integrating capacitor C reduces to low level, the reference control terminal RR outputs high level again. And so forth, the single chip 1 counts the oscillating times CR of the test terminal CX in the stipulated time (for example 0.25 s).

In the third step, using the detected oscillating time CT and CR, combined with the resistance value (Rref) of the reference resistance, follow the formula: resistance value (RTP) of the thermistor RTP=(Rref)*CR/CT; then the resistance value (RTP) of the thermistor RTP can be calculated, the single chip 1 converts the resistance value (RTP) to corresponding temperature data according to the pre-determined resistance value (RTP) of the thermistor RTP—temperature comparison chart.

If the temperature signal input port 12 of the single chip 1 is the analog-digital conversion input port of the two input voltages, the thermometric component 3 can be applied with the circuit configuration of FIG. 10: the current limiting resistance Rv, the thermistor RTP, and the reference resistance Rref are series connected between the thermometric power output port Vout (digital I/O port) of the single chip 1 and the ground wire. The connector of the current limiting resistance Rv and the thermistor RTP is connected to the first voltage input port VT of the analog-digital conversion input port of the single chip 1; the connector of the thermistor RTP and the reference resistance Rref is connected to the second voltage input port—the reference input port VR of the analog-digital conversion input port of the single chip 1.

In standby state, the thermometric power input port Vout of the single chip 1 outputs low level, no current flows through the thermistor RTP, the single chip 1 doesn't sample the voltage across the thermistor RTP.

After turning into thermometric state, the thermometric power input port Vout of the single chip 1 outputs high level, there is current flow through the thermistor RTP, thus generating voltage difference signal corresponding to the temperature data; the single chip 1 samples the voltage cross the thermistor RTP through the first voltage input port VT and the reference input port VR of the analog-digital conversion input port, then combining with the know resistance value (Rref) of the reference resistance Rref, follow the formula: resistance value (RTP) of the thermistor RTP=(Rref)*(VT/VR−1), the resistance value (RTP) of the thermistor RTP can be calculated, the single chip 1 then converts the resistance value (RTP) to corresponding temperature data according to the pre-determined resistance value (RTP) of the thermistor RTP—temperature comparison chart.

Above said two kinds of the thermometric component 3 and the thermometric methods can remove the effects of the reducing voltage to temperature data when the battery is used, thus remaining the stability of the temperature data.

FIG. 11 illustrates a flow diagram of the control method of the electronic thermometer of the present invention that based on two working state: standby state and thermometric state. In standby state, the single chip controls the LCD and the thermometric component to be in not-working state; a user squeezes the electronic thermometer and shakes it to make the electronic thermometer to get a commend of entering into thermometric operation, so that the electronic thermometer turns to thermometric state from standby state. In thermometric state, the single chip controls the LCD and the thermometric component to work, if a user squeezes the thermometer and shakes it again, the electronic thermometer will get a commend of quit, then the electronic thermometer turns to standby state from thermometric state.

For example, the vibration transducer 2 of the electronic thermometer outputs high level in motion state and outputs low level in static state, as the duration of the high level motion signal of squeezing and shaking the electronic thermometer is long, and the duration of the high level motion signal of other motions like free falling, falling, collision and pumps of transportation is short, it has to be identified to avoid misoperation. As can be seen, the vibration transducer 2 has normal open and normal closed two types, the high level and low level can be exchanged.

The control method of the electronic thermometer of the present invention has following perform steps:

Step S1, the flow starts, performing step S2.

Step S2, in standby state, the single chip 1 controls the LCD 4 and the thermometric component 3 to be in inoperation state; the LCD 3 doesn't display any information; performing step S3.

Step S3, shaking identification, the single chip 1 detects whether the vibration transducer 2 provides a squeezing signal, if the single chip 1 detects that the duration of the motion signal of the vibration transducer 2 reaches to the rated value, it determines that someone squeezes the electronic thermometer and shakes it, the single chip 1 sends a commend of entering into thermometric operation to the electronic thermometer, performing step S4; otherwise returning to step S2.

Step S4, in thermometric state, the single chip 1 controls the LCD 4 and the thermometric component 3 to be in operation state; the single chip 1 converts the temperature signal provided by the thermometric component 3 to digital value at regular intervals (for example 0.5 s), every new digital value comes in, the single chip 1 checks whether the new digital value is larger than the digital value of the LCD 4, if so, the new digital value is displayed in the LCD 4; performing step S5;

Step S5, shaking identification, the single chip 1 detects whether the vibration transducer 2 provides a squeezing signal, if the single chip 1 detects that the duration of the motion signal of the vibration transducer 2 reaches to the rated value, it determines that someone squeezes the electronic thermometer and shakes it, the single chip 1 sends a commend of quit to the electronic thermometer, performing step S2 to return to standby state; otherwise returning to step S4.

FIG. 12 illustrates a shaking identification method. In this embodiment, the step S3 has following substeps:

Substep S30, starting the subflow, performing substep S31.

Substep S31, waiting for a motion signal to trigger, once the single chip 1 detects a motion signal of the vibration transducer 2 from a static state to a motion state, performing the substep S32.

Substep S32, starting the timer, the single chip 1 starts the timer with loop count, then performing substep 33;

substep S33, determining a static signal to trigger, the single chip 1 detects whether there is a signal of the vibration transducer from the motion state to the static state, if so, performing substep S31 to restart the squeeze identification; if not, performing substep S34;

substep S34, determining whether it reaches to motion time threshold value, the single chip 1 detects whether the value of the timer reaches to the preset threshold value of motion duration (the rated value), if so, it determines that there is someone squeezing the electronic thermometer and shakes it, it sends a commend of entering into the thermometric operation, performing substep S35, if not, performing substep S33;

substep S35, the end, the single chip turns off the timer.

In this shaking identification embodiment, the substep of the step S5 to perform shaking identification is similar to the step S3, the difference is that a user squeezing the electronic thermometer and shaking it means to send a quit commend to the electronic thermometer.

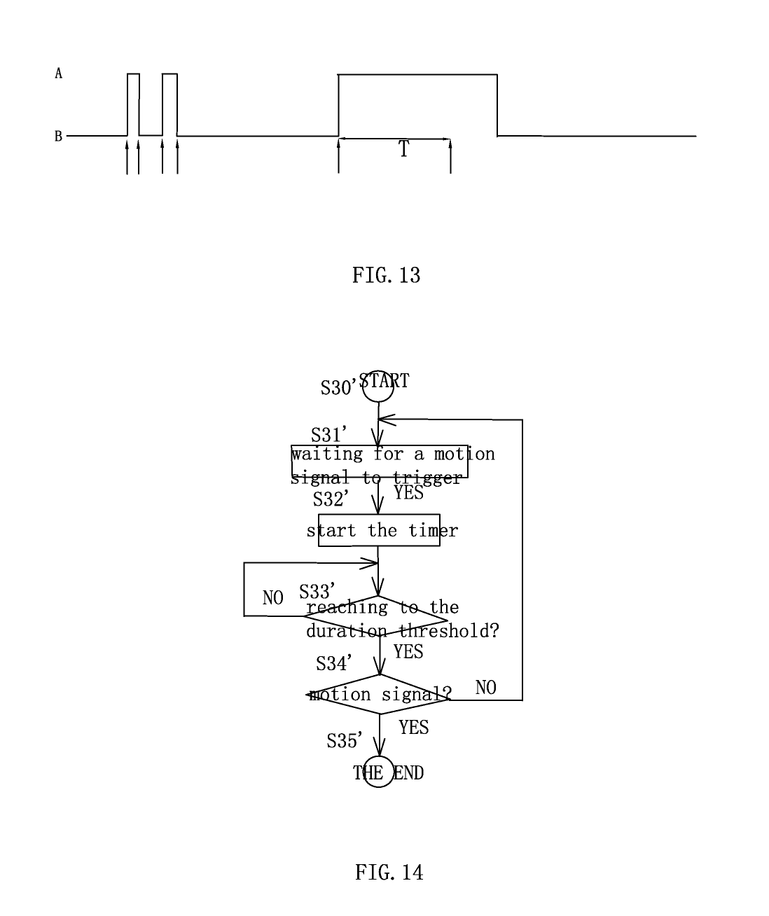

FIG. 13 illustrates the identification of the motion signal of someone squeezing the thermometer and shaking it and other motions that the vibration transducer 2 of the electronic thermometer outputs high level A in motion state and outputs low level B in static state.

In FIG. 13, the first arrow counting from left to right means that from the low level B of static state to high level A of motion state, the vibration transducer 2 produces a motion signal to trigger the counter of the single chip 1 to count the motion duration, the second arrow means that from the high level A of motion state to low level B of static state, the vibration transducer 2 produces a static signal to trigger, as the motion duration doesn't reach to the duration threshold, the single chip 1 determines that it is an output signal of other motions of the vibration transducer 2, thus controlling the electronic thermometer to remain the primary state.

In FIG. 13 the third arrow means that from the low level B of static state to high level A of motion state, the vibration transducer 2 produces a motion signal to trigger the counter of the single chip 1 to count the motion duration, the fourth arrow means that from the high level A of motion state to low level B of static state, the vibration transducer 2 produces a static signal to trigger, as the motion duration hasn't reaches to the duration threshold, the single chip 1 determine that it is an output signal of other motions of the vibration transducer 2, thus controlling the electronic thermometer to remain the primary state.

In FIG. 13, the fifth arrow means that from low level B of static state to high level A of motion state, the vibration transducer 2 produces a motion signal to trigger the counter of the single chip 1 to count the duration, the sixth arrow means that the duration of the counter of the single chip 1 reaches to the motion duration threshold T, the single chip 1 determines that it is an output signal of the vibration transducer 2 produced by squeezing and shaking, and controlling the electronic thermometer to enter to the next state: thermometer state or standby state.

The motion duration threshold T depends on the sensitivity of the vibration transducer 2, for sensitive vibration transducer 2, the motion duration threshold T can be set longer, for example 100 ms, for vibration transducer 2 with low sensitivity, the motion duration threshold T can be set shorter, for example 90 ms.

FIG. 14 illustrates a second kind of shaking identification mode, in this embodiment, the step S3 includes following substeps:

Substep S30′, start the subflow, performing substep S31′.

substep S31′, waiting for a motion signal to trigger, once the single chip detects a motion signal of the vibration transducer from a static state to a motion state, performing the substep S32′;

substep S32′, starting the timer, the single chip 1 starts the timer with loop count, then performing substep S33′;

substep S33′, determining whether it reaches to the duration threshold value, the single chip detects whether the value of the timer reaches to the preset threshold value, if so, performing substep S34′, if not, performing this substep again;

substep S34′, determining a motion signal, the single chip 1 detects whether the vibration transducer 2 outputs a motion signal, if so, it is someone squeezing the electronic thermometer and shaking it, the single chip 1 sends a commend to enter into the thermometric operation, performing substep S35′, if not, it is a motion signal due to other motion of the thermometer, performing substep S31′ to wait a squeezing signal.

substep S35′, the end, the single chip turns off the timer.

In this shaking identification embodiment, the substep of the step S5 to perform shaking identification is similar to the step S3, the difference is that a user squeezing the electronic thermometer and shaking it means to send a quit commend to the electronic thermometer.

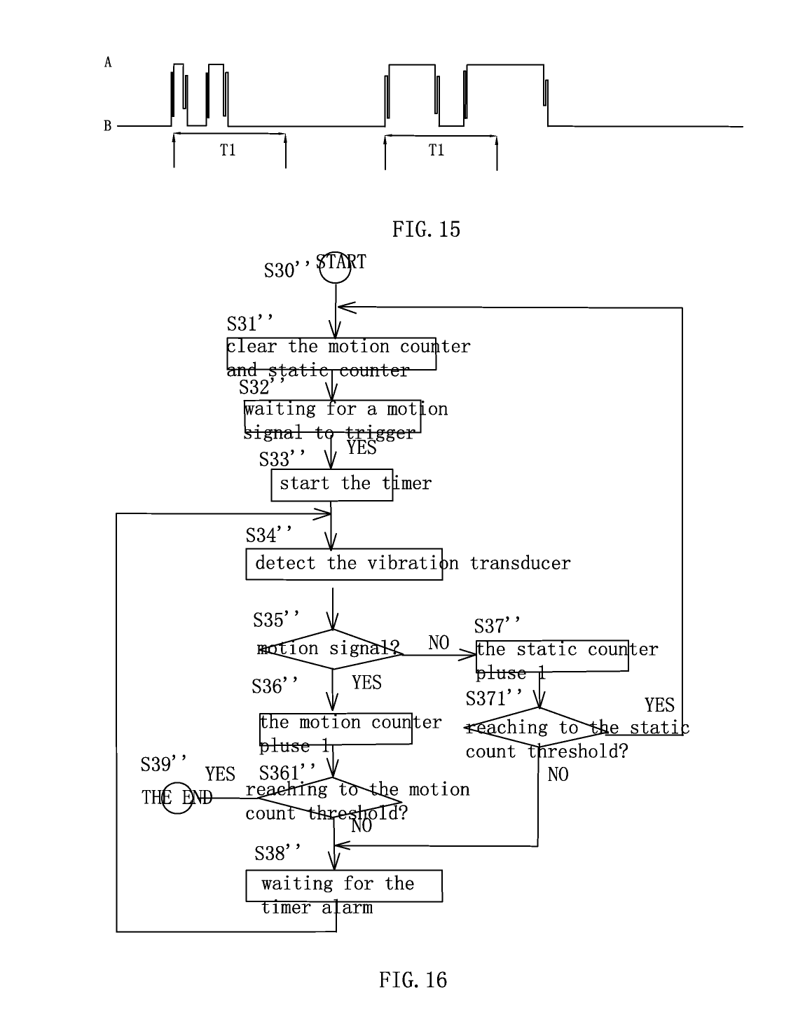

FIG. 15 illustrates the identification of the motion signal of someone squeezing the thermometer and shaking it and other motions that the vibration transducer 2 of the electronic thermometer outputs high level A in motion state and outputs low level B in static state.

In FIG. 15, the first arrow counting from left to right means that from the low level B of static state to high level A of motion state, the vibration transducer 2 produces a motion signal to trigger the counter of the single chip 1 to count the motion duration, the second arrow means that the duration reaches to the threshold T1, the vibration transducer 2 outputs low level B in static state, during this time, the vibration transducer 2 outputs two sets of pulse signals of motion state changed, the single chip 1 ignores it, it determines that it is an output signal of other motions of the vibration transducer 2 according to the output signal condition (static state), thus controlling the electronic thermometer to remain the primary state.

In FIG. 15, the third arrow means that from the low level B of static state to high level A of motion state, the vibration transducer 2 produces a motion signal to trigger the counter of the single chip 1 to count the motion duration, the fourth arrow means that it reaches to the duration threshold T1, the vibration transducer 2 still outputs high level A in motion state, during this time, the vibration transducer 2 outputs a sets of pulse signals of short changed for successive two times, the single chip 1 ignores it, and determining that it is an output signal of motion of the vibration transducer 2 squeezed and shaken, thus controlling the electronic thermometer to the next working state: thermometric state or standby state.

The motion duration threshold T depends on the sensitivity of the vibration transducer 2, for sensitive vibration transducer 2, the motion duration threshold T can be set longer, for example 100 ms, for vibration transducer 2 with low sensitivity, the motion duration threshold T can be set shorter, for example 90 ms.

FIG. 16 illustrates a third kind of shaking identification mode, in this embodiment, the step S3 includes following substeps:

Substep S30″, start the subflow, performing substep S31″.

substep 31″, clearing the static and motion counters, the single chip 1 clears the values of the static counter and motion counter, performing the substep S32″;

substep S32″, waiting for a motion signal to trigger, once the single chip detects a motion signal of the vibration transducer 2 from a static state to a motion state, performing the substep S33″;

substep S33″, starting the timer, the single chip starts the timer with loop count, then performing substep S34″;

substep S34″, detecting the state of the vibration transducer, the single chip 1 detects the output signal of the vibration transducer 2, performing substep S35″;

substep S35″, determining whether there is a motion signal, the single chip 1 detects whether the vibration transducer 2 outputs a motion signal, if so, performing substep S36″, if not, performing substep S37″;

substep S36″, the motion counters pluses 1, the single chip 1 pluses 1 to the motion counter, performing substep S361″;

substep S361″, determining whether the motion counter reaches to threshold value, the single chip detects whether the value of the motion counter reaches to the preset threshold value, if so, performing substep S39″, if not, performing substep S38″;

substep S37′, the static counter pluses 1, the single chip 1 pluses 1 to the static counter, performing substep S371″;

substep S371″, determining whether the static counter reaches to threshold value, the single chip detects whether the value of the static counter reaches to the preset threshold value, if so, it is a motion signal due to other motions of the electronic thermometer, performing substep S31″ to wait for the shaking signal, if not, performing substep S38″;

substep S38″, waiting for the time alarm, the single chip 1 waits for the time alarm signal, then performing substep S34″,

substep S39″, the end, the single chip turns off the timer.

In this shaking identification embodiment, the substep of the step S5 to perform shaking identification is similar to the step S3, the difference is that a user squeezing the electronic thermometer and shaking it means to send a quit commend to the electronic thermometer.

The timing interval of the timer, the motion count threshold and the static count threshold depend on the sensitivity of the vibration transducer 2, for example, the timing interval of the timer is set 10 ms, the motion count threshold and the static count threshold are figured below.

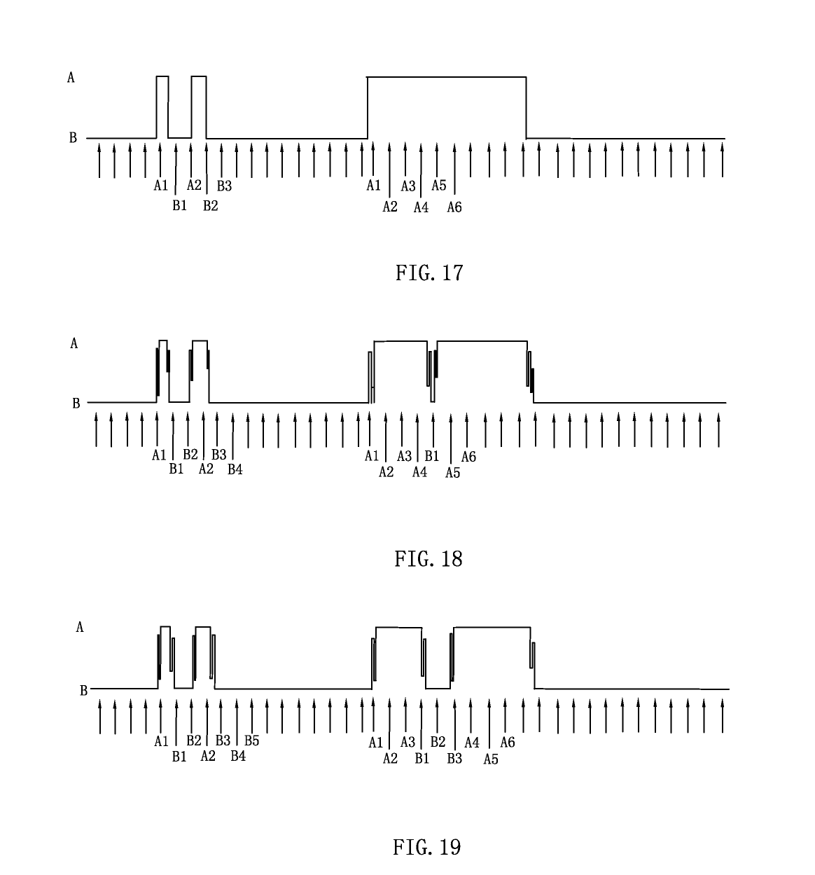

FIG. 17, FIG. 18, FIG. 19 respectively illustrate the identification of the motion signal of someone squeezing the thermometer and shaking it and other motions that the vibration transducer 2 of the electronic thermometer outputs high level A in motion state and outputs low level B in static state.

In FIG. 17, FIG. 18, FIG. 19, A1 is for 1 time of the detected motion signal, A2 is for 2 times of detected motion signal, and so forth; B1 is for 1 time of the detected static signal, B2 is for 2 times of detected static signal, and so forth.

In FIG. 17, the number threshold of static state is set 3, that is to say, when the number of the low level B of detected static state reaches to 3, it determines that the motion signal is produced by other motions of the electronic thermometer, the static and motion counters are cleared, and controlling the electronic thermometer to stay in the primary working state.

In FIG. 17, the number threshold of motion state is set 6, that is to say, when the number of the high level A of detected motion state reaches to 6, it determines that the motion signal is produced by someone squeezing the electronic thermometer and shaking it, the static and motion counters are cleared, and controlling the electronic thermometer to the next working state.

As figured in FIG. 17, at the beginning, the vibration transducer 2 outputs two sets of pulse signal of motion state changed, the single chip 1 ignore it, when B3 appears, the single chip 1 identifies it a motion signal due to other motions of the electronic thermometer, and controlling it to keep in the primary working state. When A6 appears, the single chip 1 identifies it a motion signal due to someone squeezing it and shaking it, and controlling the electronic thermometer to the next working state.

In FIG. 18, the number threshold of static state is set 4, the number threshold of static state is set 6. at the beginning, the vibration transducer 2 outputs two sets of pulse signal of motion state changed, the single chip 1 ignore it, when B4 appears, the single chip 1 identifies it a motion signal due to other motions of the electronic thermometer, and controlling it to keep in the primary working state. Following, the vibration transducer 2 outputs a set of pulse signal of state changed due to unstable condition during shaken, the single chip 1 ignores it, when A6 appears, the identifies it a motion signal due to someone squeezing it and shaking it, and controlling the electronic thermometer to the next working state.

In FIG. 19, it sets the detecting frequency threshold of the static state of 5, and the detecting frequency threshold of the motion state of 6. At the beginning, the vibration transducer 2 outputs two sets of pulse signals of change of motion state, the single chip 1 ignores them, when B5 appears, the single chip 1 identifies it a motion signal due to other motions of the electronic thermometer, and controlling it to keep in the primary working state. Following, the vibration transducer 2 outputs a set of pulse signal of short changed due to two times succession shaking, the single chip 1 ignores it, when A6 appears, the single chip 1 identifies it a motion signal due to someone squeezing it and shaking it, and controlling the electronic thermometer to the next working state: thermometric state or standby state.

As the electronic thermometer of the present invention is applied with above control flow and shaking identification state, the single chip 1 of the electronic thermometer can identify automatically the output signals of the vibration transducer 2 produced by other motions or produced by a user squeezing and shaking the thermometer, only a motion that the electronic thermometer is squeezed and shaken can make the electronic thermometer turning into the next working state: measuring temperature or standby. Squeezing and shaking the thermometer is traditional usual move, it is easy to operate and it avoids misoperation.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

### INDUSTRIAL APPLICABILITY

The present invention is provided with an electronic thermometer and a control method of the electronic thermometer, the electronic thermometer is configured with a vibration device that, when a user shake the thermometer, can turn to measure temperature from standby state, or turn to standby from measuring state. The present invention is designed appropriately, and it is easy to manufacture, thus provided with well industrial applicability.

1. An electronic thermometer, comprising a single chip, a thermometric component, an LCD, a circuit board, a housing and battery;
the circuit board is disposed with a switch type vibration transducer to provide a vibration signal to the control input port of single chip, the vibration transducer comprises a conductive elastic body and a conductive fixed body;
when the housing moves, the elastic body turns into being separated from the fixed body from being contacted with the fixed body; or the elastic body turns into being contacted with the fixed body from being separated from the fixed body.

2. The electronic thermometer according to claim 1, wherein the vibration transducer is a normally open switch type vibration transducer, the elastic body is a coil spring, the fixed body is a cylinder; the coil spring is suspended in the inner hole of the fixed body.

3. The electronic thermometer according to claim 1, wherein the vibration transducer is a normally open switch type vibration transducer, the elastic body is a coil spring, the fixed body is a rod; the fixed body is suspended in the inner hole formed by the coil spring.

4. The electronic thermometer according to claim 1, wherein the vibration transducer is a normally closed switch type vibration transducer, the elastic body is a coil spring with the free end disposed with a metal block, the fixed body is a cylinder; the elastic body is suspended in the inner hole of the fixed body, and the metal block of the free end of the elastic body is contacted with the bottom of the inner hole of the fixed body.

5. The electronic thermometer according to claim 1, wherein the vibration transducer is a normally open switch type vibration transducer, the elastic body is a coil spring with the free end disposed with a metal block, the fixed body is a cylinder; the elastic body is suspended vertically in the inner hole of the fixed body, a gap is disposed between the metal block of the free end of the elastic body and the bottom of the inner hole of the fixed body.

6. The electronic thermometer according to claim 1, wherein the vibration transducer is a normally open switch type vibration transducer, the elastic body is a shrapnel with the free end disposed with a metal block, the fixed body is a cylinder; the elastic body is suspended in the inner hole of the fixed body, a gap is disposed between the metal block of the free end of the elastic body and the side wall of the inner hole of the fixed body.

7. The electronic thermometer according to claim 1, wherein the vibration transducer is a normally closed switch type vibration transducer, the elastic body is a shrapnel with the free end disposed with a metal block, the fixed body is a cylinder; the elastic body is suspended in the inner hole of the fixed body, the metal block of the free end of the elastic body is contacted with the side wall of the inner hole of the fixed body.

8. A control method of the electronic thermometer according to claim 1, the electronic thermometer has two working state, standby state and thermometric state;
in standby state, the single chip controls the LCD and the thermometric component to be in inoperation state; the single chip simultaneously performs shaking identification, when the single chip detects that the duration of motion signal of the vibration transducer is equal to the rated value, a vibration signal is determined, the electronic thermometer turns to thermometric state;
in thermometric state, the single chip controls the LCD and the thermometric component to be in operation state; the single chip converts the temperature signal provided by the thermometric component to digital value at regular intervals, every new digital value comes in, the single chip checks whether the new digital value is larger than the digital value of the LCD, if so, the new digital value is displayed in the LCD; the single chip simultaneously performs shaking identification, when the single chip detects that the duration of a motion signal of the vibration transducer is equal to the rated value, a vibration signal is determined, the electronic thermometer returns to the standby state.

9. The control method of the electronic thermometer according to claim 8, wherein the shaking identification of the standby state and the thermometric state comprises following substeps:
substep 1, waiting for a motion signal to trigger, once the single chip detects a motion signal of the vibration transducer from a static state to a motion state, performing the substep 2;
substep 2, starting the timer, the single chip starts the timer with loop count, then performing substep 3;
substep 3, determining a static signal to trigger, the single chip detects whether there is a signal of the vibration transducer from the motion state to the static state, if so, performing substep 1, if not, performing substep 4;
substep 4, determining whether it reaches to motion time threshold value, the single chip detects whether the value of the timer reaches to the preset threshold value of motion duration, if so, performing substep 5, if not, performing substep 3;
substep 5, the end, the single chip turns off the timer.

10. The control method of the electronic thermometer according to claim 8, wherein the shaking identification of the standby state and the thermometric state comprises following substeps:
substep 1′, waiting for a motion signal to trigger, once the single chip detects a motion signal of the vibration transducer from a static state to a motion state, performing the substep 2′;
substep 2′, starting the timer, the single chip starts the timer with loop count, then performing substep 3′;
substep 3′, determining whether it reaches to the duration threshold value, the single chip detects whether the value of the timer reaches to the preset threshold value, if so, performing substep 4′, if not, performing this substep again;
substep 4′, determining a motion signal, the single chip detects whether the vibration transducer outputs a motion signal, if so, performing substep 5′, if not, performing substep 1′;
substep 5, the end, the single chip turns off the timer.

11. The control method of the electronic thermometer according to claim 8, wherein the shaking identification of the standby state and the thermometric state comprises following substeps:
substep 1″, clearing the static and motion counters, the single chip clears the values of the static counter and motion counter, performing the substep 2″;
substep 2″, waiting for a motion signal to trigger, once the single chip detects a motion signal of the vibration transducer from a static state to a motion state, performing the substep 3″;
substep 3″, starting the timer, the single chip starts the timer with loop count, then performing substep 4″;
substep 4″, detecting the state of the vibration transducer, the single chip detects the output single of the vibration transducer, performing substep 5″;
substep 5″, determining whether there is a motion signal, the single chip detects whether the vibration transducer outputs a motion signal, if so, performing substep 6″, if not, performing substep 7″;
substep 6″, the motion counters pluses 1, the single chip pluses 1 to the motion counter, performing substep 61″;
substep 61″, determining whether the motion counter reaches to threshold value, the single chip detects whether the value of the motion counter reaches to the preset threshold value, if so, performing substep 9″, if not, performing substep 8″;
substep 7′, the static counter pluses 1, the single chip pluses 1 to the static counter, performing substep 71″;
substep 71″, determining whether the static counter reaches to threshold value, the single chip detects whether the value of the static counter reaches to the preset threshold value, if so, performing substep 1″, if not, performing substep 8″;
substep 8″, waiting for the time alarm, the single chip 1 waits for the time alarm signal, then performing substep 4″,
substep 9″, the end, the single chip turns off the timer.
